(19) United States
(12) Patent Application Publication
(10) Pub. No.: US 2003/0050191 A1
(43) Pub. Date: Mar. 13, 2003

(54) Imaging medium incorporating a polymeric developer for leuco dye

(76) Inventors: Jayprakash C. Bhatt, Waltham, MA (US); Daoshen Bi, Burlington, MA (US); Kuang-Chou Chang, Lexington, MA (US); Feng Y. Dai, Framingham, MA (US)

Correspondence Address: Polaroid Corporation, Patent Department, 784 Memorial Drive, Cambridge, MA, 02139, US

(21) Appl. No.: 09/866,676

(22) Filed: May 29, 2001

(51) Int. Cl. B41M 5/30

(52) U.S. Cl. 503/216

(57) ABSTRACT

An imaging medium comprises a color change layer containing a leuco dye. An acidic developing layer comprising a polyhydroxystyrene reacts with said color change layer to produce a color upon the application of heat. The polyhydroxystyrene may be used alone or in combination with traditional leuco dye developers.

### BACKGROUND OF THE INVENTION

This invention relates to a heat sensitive imaging medium incorporating a novel polymeric developer for leuco dye. This invention also relates to a method of producing a change in a color layer using a novel polymeric developer for leuco dye.

Generally, a thermosensitive recording material comprises a support and a thermosensitive coloring layer formed thereon, which comprises as the main components a colorless or light colored dye precursor, and a color developer. The dye precursor and color developer react instantaneously upon the application of heat thereto to produce recorded images, for instance, using a thermal head, heat pen or laser beam.

Thermally sensitive recording material is used in a wide variety of fields, for example, as the recording material for an electronic computer, facsimile apparatus, ticket vending apparatus, label printer, and recorder because it has the advantages that recording can be achieved using a relatively simple apparatus, maintenance is simple, and they are typically quiet.

Direct thermal printers are well known in the prior art. Typically, a coated paper is heated, causing a color change due to a chemical reaction. Chelate recording papers use salts of organic acids and organic reducing agents to produce an image. Leuco dye media are known which contain colorless dye precursors and dye developers. When heated, the acidic dye developer reacts with the dye precursor, producing a color change. Using these systems, it has in the past been difficult to obtain highly detailed images, thus limiting the utility of the printers.

Printers based upon a process known as “thermal wax transfer”, or, more correctly, “thermal mass transfer” are available commercially. Such printers use an imaging medium (usually called a “donor sheet” or “donor web”) which, in the case of a color printer, comprises a series of panels of differing colors. Each panel comprises a substrate, typically a plastic film, carrying a layer of fusible material, conventionally a wax, containing a dye or pigment of the relevant color. To effect printing, a panel is contacted with a receiving sheet, which can be paper or a similar material, and passed across a thermal printing head, which effects imagewise heating of the panel. At each pixel where heat is applied by the thermal head, the layer of fusible material containing the dye or pigment transfers from the substrate to the receiving sheet, thereby forming an image on the receiving sheet. To form a fall color image, the printing operation is repeated with panels of differing colors so that three or four images of different colors are superposed on a single receiving sheet.

Thermal wax transfer printing is relatively inexpensive and yields images which are good enough for many purposes. However, the resolution of the images which can be produced in practice is restricted since the separation between adjacent pixels is at least equal to the spacing between adjacent heating elements in the thermal head, and this spacing is subject to mechanical and electrical constraints. Also, the process is essentially binary; any specific pixel on one donor panel either transfers or does not, so that producing continuous tone images requires the use of dithering, stochastic screening or similar techniques to simulate continuous tone. Finally, some difficulties arise in accurately controlling the color of the images produced. The size of the wax particle transferred tends to vary depending upon whether an isolated pixel, or a series of adjacent pixels are being transferred, and this introduces granularity into the image and may lead to difficulty in accurate control of gray scale. Also, any given pixel in the final image may have 0, 1, 2, 3 or 4 superimposed wax particles, and the effects of the upper particles upon the color of the lower particles may lead to problems in accurate control of color balance.

Printers are also known using a process known as “dye diffusion thermal transfer” or “dye sublimation transfer”. This process is generally similar to thermal wax transfer in that a series of panels of different colors are placed in succession in contact with a receiving sheet, and heat is imagewise applied to the panels by means of a thermal head to transfer dye from the panels to the receiving sheet. In dye diffusion thermal transfer processes, however, there is no mass transfer of a binder containing a dye; instead a highly diffusible dye is used, and this dye alone transfers from the panel to the receiving sheet without any accompanying binder. Dye diffusion thermal transfer processes have the advantages of being inherently continuous tone (the amount of dye transferred at any specific pixel can be varied over a wide range by controlling the heat input to that pixel of the panel) and can produce images of photographic quality. However, the process is expensive because special dyes having high diffusivity, and a special receiving sheet, are required. Also, this special receiving sheet usually has a glossy surface similar to that of a photographic print paper, and the glossy receiving sheet limits the types of images which can be produced; one cannot, for example, produce a image with a matte finish similar to that produced by printing on plain paper, and images with such a matte finish may be desirable in certain applications. Finally, problems may be encountered with images produced by dye diffusion thermal transfer because the highly diffusible dyes tend to “bleed” within the image, for example, when contacted by oils from the fingers of users handling the images.

Finally, there is one thermal imaging system, described in, inter alia, U.S. Pat. Nos. 4,771,032; 5,409,880; 5,410,335; 5,486,856; and 5,537,140, and sold by Fuji Photo Film Co., Ltd. under the Registered Trademark “AUTOCHROME” which does not depend upon transfer of a dye, with or without a binder or carrier, from a donor to a receiving sheet. This process uses a recording sheet having three separate superposed color-forming layers, each of which develops a different color upon heating. The top color-forming layer develops color at a lower temperature than the middle color-forming layer, which in turn develops color at a lower temperature than the bottom color-forming layer. Also, at least the top and middle color-forming layers can be deactivated by actinic radiation of a specific wavelength (the wavelength for each color-forming layer being different, but both typically being in the near ultra-violet) so that after deactivation the color-forming layer will not generate color upon heating.

This recording sheet is imaged by first imagewise heating the sheet so that color is developed in the top color-forming layer, the heating being controlled so that no color is developed in either of the other two color-forming layers. The sheet is next passed beneath a radiation source of a wavelength which deactivates the top color-forming layer, but does not deactivate the middle color-forming layer. The sheet is then again imagewise heated by the thermal head, but with the head producing more heat than in the first pass, so that color is developed in the middle color-forming layer, and the sheet is passed beneath a radiation source of a wavelength which deactivates the middle color-forming layer. Finally, the sheet is again imagewise heated by the thermal head, but with the head producing more heat than in the second pass, so that color is developed in the bottom color-forming layer.

In such a process, it is difficult to avoid crosstalk between the three color-forming layers since, for example, if it is desired to image an area of the top color-forming layer to maximum optical density, it is difficult to avoid some color formation in the middle color-forming layer. Insulating layers may be provided between the color-forming layers to reduce such crosstalk, but the provision of such insulating layers adds to the cost of the medium. Print energy tends to be high, since the third pass over the thermal head to form color in the bottom color-forming layer requires heating of this layer through two superposed color-forming layers, and two insulating layers, if these are present. Finally, the need for at least two radiation sources to produce two well-separated wavelengths adds to the cost and complexity of the apparatus required.

Leuco dye chemistry has been widely adopted for use in thermal imaging applications including direct thermal paper, carbonless paper and point-of-sale receipts. Although leuco dyes may provide full gray scale for full color images, image stability has been problematic. Specifically, obtaining adequate Dₘᵢₙ and Dₘₐₓ simultaneously is difficult using leuco dyes.

The image forming reaction based upon leuco dye chemistry has long been acknowledged as an acid-base reaction between a basic leuco dye and a weak acidic developer. Commonly used acidic developers include phenol derivatives such as bisphenol-A, benzyl paraben, monohydroxy and dihydroxy diphenyl sulfones, acidic clays, phenolic resins and zinc salicylates. Adequate Dₘᵢₙ stability may be obtained using the phenol derivatives. These compounds also provide high density at low print energy, however, they do not provide acceptable Dₘₐₓ stability. Good Dₘₐₓ stability may be obtained using phenolic resins and zinc salicyates, but these compounds are known to provide poor Dₘᵢₙ stability.

This invention discloses an imaging medium containing a novel polymeric developer for leuco dyes. Specifically, linear, branched and co-polymers of polyhydroxystyrene (PHS) are disclosed for use as acidic leuco dye developers and as co-developers in combination with traditional leuco dye developers. Use of PHS alone and in combination with traditional dye developers provides good Dₘᵢₙ and Dₘₐₓ stability simultaneously, allowing highly detailed images to be produced utilizing a direct thermal media.

### SUMMARY OF THE INVENTION

Accordingly, this invention provides an imaging medium comprising a substrate carrying a color change layer composed of at least one leuco dye and a leuco dye developer being capable of reacting, upon heating of the medium, to cause a change in the color of the color-change layer. The dye developer may be either polymers containing units of hydroxystyrene alone or in combination with other leuco-dye developers.

This invention also provides a method of producing a color layer by exposing a color-change layer consisting of a leuco dye and a leuco dye developer to heat. The dye developer may be either polymers containing units of hydroxystyrene alone or in combination with other leuco-dye developers.

### DESCRIPTION OF THE PREFERRED EMBODIMENTS

As indicated, the present processes use an imaging medium comprising a substrate carrying a color-change layer which develops color upon heating.

Very desirably, the color-forming reagents used in the processes and medium of the present invention are such that the density of the color developed as a result of the color change in the color-change layer varies with the thermal energy input to this layer. By using such color-forming reagents and varying the imagewise heating (in the imagewise-heating process) one can produce in the final image colored pixels of color-change layer having differing color densities, thus producing a continuous tone image, in contrast to the essentially binary images produced by conventional thermal mass transfer processes.

As the leuco dye for use in the present invention, which may be employed alone or in combination, any conventional dyes for use in the conventional leuco-dye-containing recording materials can be employed. For example, triphenylmethanephthalide leuco compounds, triallylmethane leuco compounds, fluoran leuco compounds, phenothiazine leuco compounds, thiofluoran leuco compounds, xanthene leuco compounds, indophthalyl leuco compounds, spiropyran leuco compounds, azaphthalide leuco compounds, couromeno-pyrazole leuco compounds, methine leuco compounds, rhodamineanilino-lactam leuco compounds, rhodaminelactam leuco compounds, quinazoline leuco compounds, diazaxanthene leuco compounds and bislactone leuco compounds are preferably employed.

The polyhydroxystyrene of the present invention may be utilized in linear, branched and co-polymer forms. It is anticipated further that substitutions on the polymer backbone and on the aromatic ring may also yield the beneficial results of this invention. Very desirably the PHS may be a linear chain PHS such as that manufactured and sold by Triquest, LP, Dallas, Tex., having Chem. Abstracts No. 24979-70-2 and having generally the chemical structure I identified below.

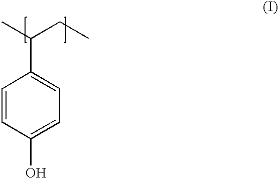

A branched PHS may also be used in the present invention. An example of a branched PHS is manufactured and marketed by Triquest, LP having Chem. Abstracts No.166164-76-7 and having the general structure II identified below, where n is a positive integer.

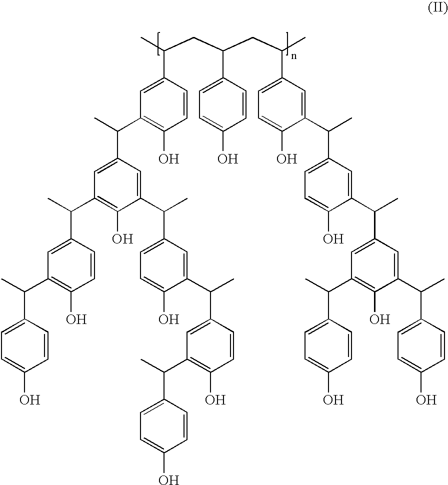

Additionally, it is anticipated that co-polymers of PHS with acrylates, alkylacrylates, styrenics, vinylics, butadienes and other unsaturated monomers may be used in the present invention. An example of an appropriate PHS co-polymer is manufactured and marketed by Triquest, LP and having generally the chemical structure III identified below.

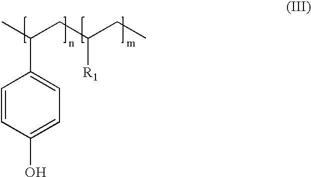

The color co-developer of the present invention may be any of the aromatic phenol color developers known or used in the thermal media art to form a colored reaction product. The preferred co-developers are selected from the group of commonly used acidic developers such as bisphenol-A, benzyl paraben, dihydroxy diphenyl sulfone, acid clays, polymeric or oligomeric hydroxy sulfones, phenolic resins and zinc salicylates. A general review of color developers useful in color forming reactions can be found in James, T. H., The Theory of the Photographic Process, 4th Ed., MacMillian Publishing Co., Inc., New York, N.Y. (1977), in particular at pages 335 through 362.

In addition to the color-forming reagents, the color-forming layer will normally comprise a binder. The binders used in conventional thermal wax transfer imaging, for example natural or synthetic waxes or resins, may also be used in the present imaging medium. Ultra-violet absorbers may also be incorporated into this color-change layer to improve the light stability of the image.

The exact nature of the substrate used in the present imaging medium is not critical provided that this substrate provides adequate mechanical support for the color-change layer during storage, transport and imaging, has sufficient thermal conductivity not to interfere with the imaging process. Typically, the substrate will be a plastic film, such as that sold under the Registered Trademark “Melinex” by Du Pont De Nemours Ei & Corporation, Martinsville, Va. After imaging, various post-treatment steps may be effected to vary the appearance of and/or to protect the image. For example, the image may be subjected to heat treatment to change its gloss, and may have a protective laminate secured over the color-change layer(s) to change the image's appearance or to protect it from mechanical damage.

The present invention will be described in greater detail with reference to the following examples, which are in no way limiting.

### EXAMPLE 1

A leuco dye dispersion was prepared by dispersing leuco dye in an aqueous mixture consisting of partially hydrolyzed poly(vinyl alcohol), surfactants and deionized water using an attriter equipped with glass beads. Appropriate leuco dyes in cyan, magenta and black are available from B. F. Goodrich-Hilton. An appropriate yellow leuco dye is available from Ciba Specialty Chemicals. Examples of these dyes are detailed in structures IV, V and VI below. The mixture was stirred for 16 hours at ambient temperature, resulting in a dispersion approximately 25% solid with an average particle size of 0.4-0.8 μm.

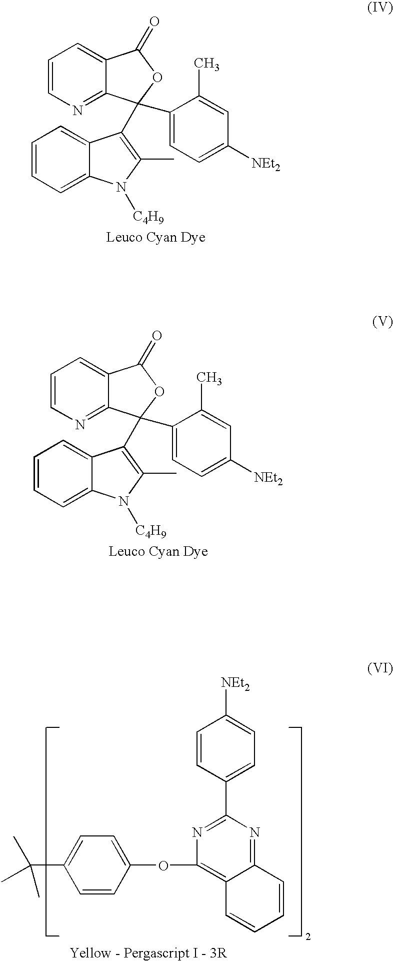

The phenol derivative developer was prepared in almost the same manner, however, in order to obtain fine dispersion, additional surfactants were used. The resulting fluid was approximately 30% solid with an average particle size of 0.5-1.0 μm.

A dispersion of poly(hydroxystyrene) is prepared by attriting a mixture consisting of poly(hydroxystyrene) with Irganox 1035 available from Ciba Specialty Chemicals, surfactant Dowfax 2A1 obtained from Dow Chemicals, partially hydrolyzed poly(vinylalcohol) and deionized water. The mixture was attrited for 18-24 hr at 2-4° C. resulting in a dispersion with an average particle size of 0.4-0.7 μm.

A medium was prepared with the dye formulation layer coated out of an aqueous solution containing dispersions of dye, acidic developer, binder material and surfactants onto a PET substrate.

Table 1 demonstrates several cyan formulations utilizing PHS as both a developer and as a co-developer in combination with more traditional developers.

TABLE 1

| | Leuco Cyan | | | Binder | Wax |
|---|---|---|---|---|---|
| Formulation | Dye % | PHS % | Other Developer | Joncryl 540 | Michelman 124 |
| LCF072699A | 19.2% | 73.5% | 0.0% | 5.0% | 2.3% |
| LCF072699B | 22.5% | 48.0% | Bisphenol-A | 5.0% | 2.0% |
| | | | 22.5% | | |
| LCF072699C | 22.5% | 48.0% | Zinc salt of 5-Octyl-3- | 5.0% | 2.0% |
| | | | Methyl Salicylic Acid | | |
| | | | 22.5% | | |
| LCF072699D | 22.5% | 48.0% | Benzyl Paraben | 5.0% | 2.0% |
| | | | 22.5% | | |
| LCF080399A | 27.0% | 27.0% | Benzyl Paraben | 7.0% | 3.0% |
| | | | 27.0% | | |
| LCF073099B | 27.0% | 0.0% | Benzyl Paraben | 7.0% | 3.0% |
| | | | 53.0% | | |
| LCF073099D | 27.0% | 0.0% | Bisphenol-A | 7.0% | 3.0% |
| | | | 53.0% | | |

Table 2 contains data for cyan densities after printing and after the printed paper was aged at 40° C. and at 90% relative humidity for 24 hours. As is evident from the data, image stability was significantly improved when PHS was used as alone as a developer, or as a co-developer in conjunction with traditional means. Although PHS may be used alone as a developer, it requires the use of much higher printing energies than that of traditional developers. It is advantageous, therefore, to utilize PHS in conjunction with co-developers to obtain the best possible results.

TABLE 2

| | Dmax (Heat Stamp @ | | | | Midtone | |
|---|---|---|---|---|---|---|
| | 300° F. for 0.01 sec) | | Dmax(print) | | (3.0 J/cm2) | |
| | Before | After | Before | After | Before | After |
| LCF72699A | 1.73 | 1.69 | 1.55 | 1.61 | 0.3 | 0.34 |
| LCF72699B | 1.85 | 1.84 | 1.87 | 1.89 | 1.05 | 1.66 |
| LCF72699C | 1.76 | 1.76 | 1.76 | 1.84 | 0.47 | 0.74 |
| LCF72699D | 2.04 | 2.06 | 1.71 | 1.73 | 0.89 | 0.93 |
| LCF080399A | 1.01 | 1.06 | 0.92 | 1.06 | 0.5 | 0.55 |
| LCF73099B | 1.72 | 0.84 | 1.35 | 0.61 | 1.29 | 0.2 |
| LCF73099D | 1.8 | 0.95 | 1.7 | 0.73 | 1.15 | 0.35 |

Similar results were obtained when PHS was used as a developer or co-developer with magenta and yellow dye formulations, as illustrated in Table 3.

TABLE 3

| | Leuco | | Developers | | Binder | Wax |
|---|---|---|---|---|---|---|
| | Dye | Dye | PHS | Paraben | Joncryl 540 | Michelman 124 |
| LMF080399B | Copikem 16 | 27.0% | 27.0% | 27.0% | 7.0% | 3.0% |
| LYF080399C | Yellow | 27.0% | 27.0% | 27.0% | 7.0% | 3.0% |
| | Pergascript | | | | | |
| | I-3R | | | | | |

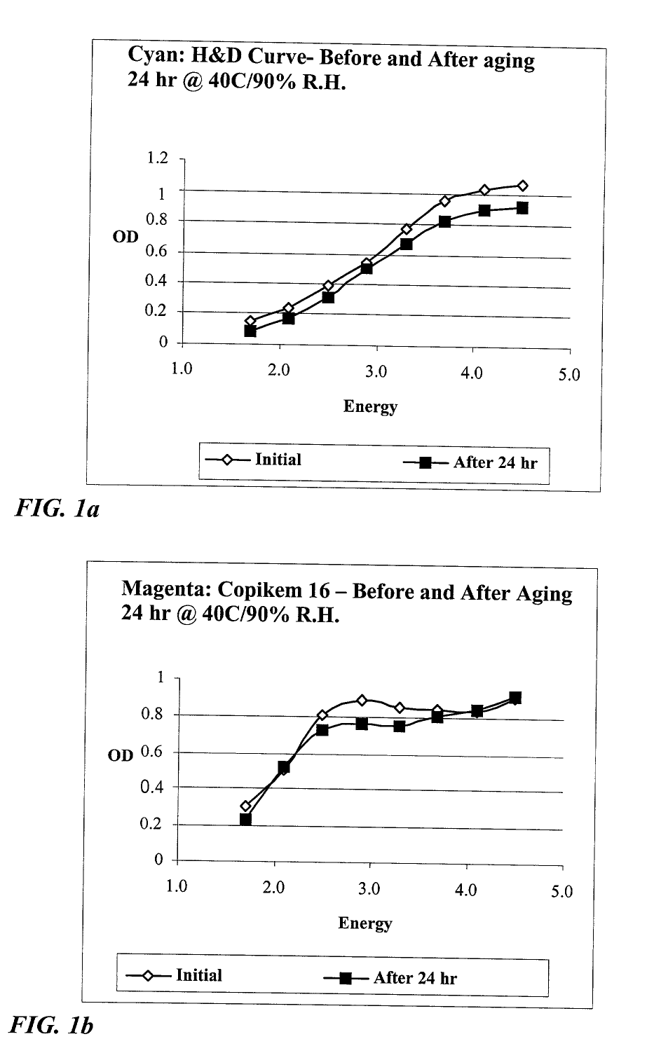

FIGS. 1a, 1b and 1c chart the humidity/density curves for cyan, magenta and yellow formulations. The data confirm that use of PHS as a co-developer greatly enhances image stability.

### EXAMPLE 2

A dispersion of phenol-4,4′-sufonyl bis-2-(2-propenyl) marketed by Nippon Kayaku Company, Tokyo, Japan under the name TG-SA (92.27% by weight) was dispersed in an aqueous mixture comprising 3.69% partially hydrolyzed poly(vinyl alcohol) manufactured by Air Products, Inc., Allentown, Pa., 3.23% Dowfax-2A1 manufactured by Dow Chemical Corporation, Midland, Mich., surfactants and deionized water using an attriter with glass beads. Alternatively, monohydroxy diphenol sulfone marketed by Nippon Soda, Tokyo, Japan under the name D-8 could be substituted for TG-SA. Phenol-4,4′-sufonyl bis-2-(2-propenyl) (TG-SA) is illustrated as structure VII below.

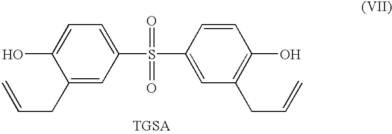

Monohydroxy diphenol sulfone (D-8) is illustrated as structure VIII below.

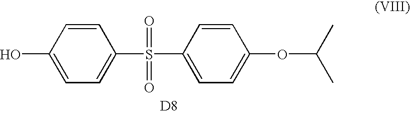

The dispersion was stirred for 15 hours at ambient temperature, resulting in an average particle size of under 1.0 μm.

A leuco black dye, Copikem 34 (79.0%) manufactured by BF Goodrich Corp., Cincinnati, Ohio was dispersed in an aqueous mixture comprising 4.4% partially hydrolyzed poly(vinyl alcohol) manufactured by Air Products, Inc., 5.0% Irganox 1035, 5.0% Tinuvin 328 (both available from CIBA Specialty Chemicals) along with surfactants and de-ionized water. Copikem 34 is illustrated as structure IX below.

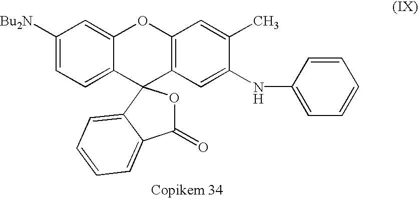

The dispersion was prepared using an attriter equipped with glass beads and stirred for 16 hours at ambient temperature. The average particle size of the resulting dispersion was approximately 0.39 μm.

An imaging medium was prepared using the dispersions discussed above and a protective slip coat, all coated onto a Melinex 534 substrate. The dispersions of phenol-4,4′-sulfonyl bis-2(2-propenyl), polyhydroxystyrene and leuco dye were used to prepare a coating fluid in various proportions, as indicated in Table 4, below.

TABLE 4

| | Leuco Dye | Developer | Co-developer | Binder | Surfactant |
|---|---|---|---|---|---|
| Formulation | Copikem 34 | TG-SA | PHS | PVA 205 | FC-100 |
| B&W-0711-6a | 30.0% | 52.0% | 0.0% | 17.8% | 0.2% |
| B&W-0711-7 | 30.0% | 0.0% | 52.0% | 17.8% | 0.2% |
| B&W-0627-3 | 28.0% | 38.0% | 12.0% | 21.8% | 0.2% |

The coating compositions of table 4 were coated onto a white reflector Melinex 534 base with a thickness of 3.80 mil available from Du Pont De Nemours Ei & Corporation, Martinsville, Va., using a Meyer rod. The intended coating thickness was 2.60 μm. The resulting imaging layer was air dried, and a protective slip coat was coated onto the imaging layer using a Meyer rod with a coating 10 thickness of 0.98 μm. The proportions of the protective slip coat are listed in Table 5, below.

TABLE 5

| Ingredient | % solids in dried film |
|---|---|
| Hymicron ZK-349 | 31.87% |
| Klebosol 30R25 | 23.84% |
| Glyoxal | 9.58% |
| FC-100 surfactant | 1.38% |
| PVA 540 | 31.79% |

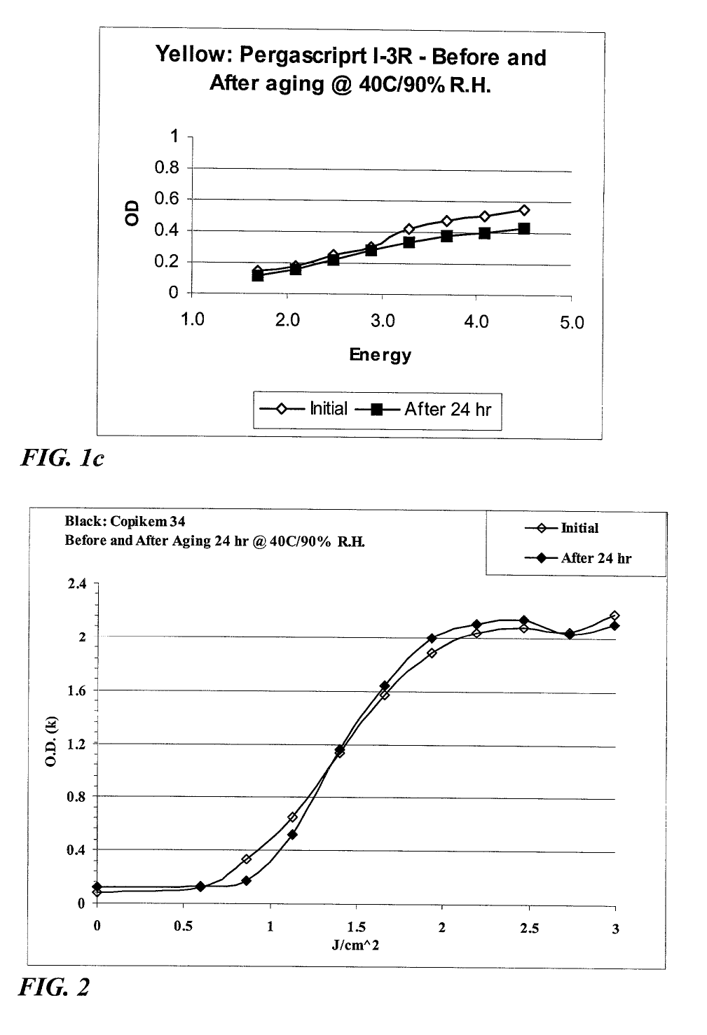

The imaging medium prepared as discussed above was used in an Atlantek thermal response test printer equipped with a 300 dpi thermal print head and printing at a speed of 0.55 inches per second, or 14 millimeters per second. A high density continuous tone black image and a good quality test image were printed successfully. The resulting image demonstrated excellent stability when exposed to humidity, time and temperature testing. FIG. 2 plots the black and white humidity /intensity curve.

Table 6 below details several coating formulations that demonstrated excellent image stability.

TABLE 6

| Form- | % Leuco | | | % PVA | Surfactant |
|---|---|---|---|---|---|
| ulation | dye | % TG-SA | % PHS | 205 | % FC-100 |
| 1 | 30.0% | 30.0% | 10.0% | 29.8% | 0.2% |
| 2 | 26.0% | 40.0% | 12.0% | 21.8% | 0.2% |
| 3 | 20.0% | 40.0% | 20.0% | 19.8% | 0.2%% |
| 4 | 28.0% | 38.0% | 12.0% | 21.8% | 0.2% |
| 5 | 30.0% | 34.0% | 18.0-26.0% | 17.8-9.8% | 0.2% |

Although the invention has been described in detail with respect to various preferred embodiments thereof, those skilled in the art will recognize that the invention is not limited to these embodiments, but rather that variations and modifications are possible which are within the spirit of the invention and the scope of the appended claims.

We claim:

1. A heat-sensitive recording medium having a color developing layer containing a leuco dye,
and an acidic developer which reacts with said leuco dye upon heating to form a color layer,
said acidic developer comprising a polyhydroxystyrene.

2. The heat-sensitive recording medium defined in claim 1 wherein said polyhydroxystyrene is a linear chain polyhydroxystyrene.

3. The heat-sensitive recording medium defined in claim 1 wherein said polyhydroxystyrene is a branched polyhydroxystyrene.

4. The heat-sensitive recording medium defined in claim 1 wherein said polyhydroxystyrene is a polyhydroxystyrene co-polymer.

5. The heat-sensitive recording medium defined in claim 2 wherein said linear chain polyhydroxystyrene has an average molecular weight of 500 to 100,000.

6. The heat-sensitive recording medium defined in claim 3 wherein said branched polyhydroxystyrene has an average molecular weight of 4,000 to 6,000.

7. The heat-sensitive recording medium defined in claim 1 further comprising a co-developer chosen from the group consisting of bisphenol-A, benzyl paraben, monohydroxy and dihydroxy diphenyl sulfones, acidic clays, phenolic resins and zinc salicylates.

8. The heat-sensitive recording medium defined in claim 2 further comprising a co-developer chosen from the group consisting of bisphenol-A, benzyl paraben, monohydroxy and dihydroxy diphenyl sulfones, acidic clays, phenolic resins and zinc salicylates.

9. The heat-sensitive recording medium defined in claim 3 further comprising a co-developer chosen from the group consisting of bisphenol-A, benzyl paraben, monohydroxy and dihydroxy diphenyl sulfones, acidic clays, phenolic resins and zinc salicylates.

10. The heat-sensitive recording medium defined in claim 4 further comprising a co-developer chosen from the group consisting of bisphenol-A, benzyl paraben, monohydroxy and dihydroxy diphenyl sulfones, acidic clays, phenolic resins and zinc salicylates.

11. A method of producing a color layer by providing in a medium a color developing layer containing a leuco dye and an acidic developer, said acidic developer comprising a polyhydroxystyrene, and by heating said color developing layer such that said acidic developer reacts with said leuco dye to produce a color.

12. The method of producing a color layer defined in claim 11 wherein said polyhydroxystyrene is a linear chain polyhydroxystyrene.

13. The method of producing a color layer defined in claim 12 wherein said polyhydroxystyrene is a branched polyhydroxystyrene.

14. The method of producing a color layer defined in claim 12 wherein said polyhydroxystyrene is a polyhydroxystyrene co-polymer.

15. The method of producing a color layer defined in claim 12 wherein said linear chain polyhydroxystyrene has an average molecular weight of 500 to 100,000.

16. The method of producing a color layer defined in claim 12 wherein said branched polyhydroxystyrene has an average molecular weight of 4,000 to 6,000.

17. The method of producing a color layer defined in claim 12 further comprising a co-developer chosen from the group consisting of bisphenol-A, benzyl paraben, monohydroxy and dihydroxy diphenyl sulfones, acidic clays, phenolic resins and zinc salicylates.

18. The method of producing a color layer defined in claim 13 further comprising a co-developer chosen from the group consisting of bisphenol-A, benzyl paraben, monohydroxy and dihydroxy diphenyl sulfones, acidic clays, phenolic resins and zinc salicylates.

19. The method of producing a color layer defined in claim 14 further comprising a co-developer chosen from the group consisting of bisphenol-A, benzyl paraben, monohydroxy and dihydroxy diphenyl sulfones, acidic clays, phenolic resins and zinc salicylates.

20. The method of producing a color layer defined in claim 15 further comprising a co-developer chosen from the group consisting of bisphenol-A, benzyl paraben, monohydroxy and dihydroxy diphenyl sulfones, acidic clays, phenolic resins and zinc salicylates.
